(19) United States
(12) Patent Application Publication
(10) Pub. No.: US 2007/0289922 A1
(43) Pub. Date: Dec. 20, 2007

(54) Modular wastewater treatment system

(76) Inventors: Cesar Ladron de Guevara, Las Vegas, NV (US); Luther Freeman, Las Vegas, NV (US)

Correspondence Address: Cesar Ladron de Guevara, 3180 Seneca Dr., Las Vegas, NV, 89109, US

(21) Appl. No.: 11/452,620

(22) Filed: Jun. 15, 2006

(51) Int. Cl. C02F 3/30

(52) U.S. Cl. 210/605; 210/617; 210/151; 210/903

(57) ABSTRACT

A Modular Wastewater Treatment System is disclosed suitable for municipal, domestic and commercial sewage. After separation of the settable solids of the wastewater in the collection system or septic tank or other means the effluent is passed by gravity to the Alternating Nitrification Enhance Reactor where nitrification and de-nitrification process occurs as well as BOD sub.5 and TSS reduction by the participation of a facultative colony. Dosing, recirculation and discharge systems are linked in the alternating and intermittent cycles and facultative process with a gravel media bed to remove the remaining BOD sub.5, TSS and fecal coliform counts of the effluent. The overall system save footprint and it is fully automatic.

### BACKGROUND OF THE INVENTION

1. Field of the Invention

This invention relate a Modular Wastewater Treatment System and Method of treating wastewater, and more particular, to a modular wastewater treatment system and method having an Alternating Nitrification Enhance Reactor (ANER), dosing, recirculation, discharge tank, filter media bed with a dosing, recirculation, and nitrogen removal circulation system, where the alternating and intermittent cycles become a system in to a facultative zone in order to remove nitrogen and reduce BOD.sub.5 and TSS levels.

2. Description of the Related Art

A disposal facility of municipal, domestic and commercial wastewater (sewage) from town, subdivisions, commercial establishments, schools, golf courses, and single family residence, in areas with no conventional sewer system, where a collection system, or septic tank have been accomplished. The anaerobic effluent discharged from the collection system or septic tank, after settling of the solids portion of the incoming wastewater, is passed into a tank called Alternating Nitrification Enhance Reactor (ANER).

The Alternating Nitrification Enhance Reactor consists of a tank divided by a wall, with two differential zones and alternating cycles, including in the first zone a submerged plastic media container and in the second zone a circulation pump and a ventury device. During the cycle three stages take place in the submerged plastic media container and in the first chamber. Anoxic in the bottom, anaerobic in the middle and aerobic in the top.

During the cycle time some stages will remain in place however the aerobic stages shift in the volume and be limited to the media area surface, according to the dissolved oxygen decay.

With the development of the facultative colony the conversion of ammonia into nitrate nitrogen (NOx) Nitrification process occurs due to Nitrosomonas and Nitrobacter. Furthermore in the middle and in the bottom of the submerged plastic media container, as well as in the bottom and middle part of the first and second zones, nitrate nitrogen (NOx) is converted into nitrogen and oxygen and released into the air in the form of gaseous N. sub.2 and gaseous O sub.2 by the action of the same group of bacteria present in the organic matter taking the advantage of the raw water coming into the first zone from the collection system or septic tank under anaerobic conditions.

The pre-treated effluent flows by gravity to the dosing tank, which represents an anaerobic storage. The pumps located in the tank pump the effluent into the subsurface drain field for percolation into the surrounding gravel media. The treated effluent drains into the recirculation tank, which acts as a facultative storage area. There are pumps in this tank that pump the effluent over the gravel media surface. Part of the sprayed effluent goes to the discharge tank to be pumped to the second section of the media bed and by using the carbon anthracite the remaining nitrogen is removed. The effluent that return from this tertiary polish has been treated sufficiently to meet discharge requirements, and then goes through the discharge outlet. If the system is properly installed and if proper soil conditions exist for disposal of the effluent in the drain field.

In many areas, soil conditions are unsuitable for direct disposal of the effluent from collection systems or septic tanks. In such areas one alternative is to utilize conventional treatment plants which may use the chemical and/ or biological treatment means, such as primary, secondary and sometimes tertiary treatment including technologies as Activated-Sludge System, Extended Aeration System, Rotating Biological Contactors (RBC) and Trickling Filters are prohibitively expensive both to construct and operate. Such treatment plants are generally not economically feasible for treatment of domestic sewage for towns, subdivisions, commercial and single family. Other alternative methods of decentralized wastewater treatment are known, however, local health authorities, due to the insufficient treatment of the wastewater, have never accepted many of them.

The Nitrate level in the water is one of the most prevalent ground water contaminant worldwide. Nitrates originated from sewage-disposal or after the wastewater treatment and disposal where the nitrification process took place. However the de-nitrification process is insufficient. Ground water is also one of the most common drinking water sources for both humans and livestock in rural and suburban areas of the United States.

Process for de-nitrification by using microbiological reactors are known eliminating nitrates from the water. These processes, such as those conducted in rising current reactors containing granular de-nitrifying biomass, have been described for example, by Lettings et al., (1980) and by Timmermans, (1983).

For wastewater in particular, different reducing agents such as methane, sugars, less expensive biodegradable material, including cellulose and ethanol, have been used. These conventional reducing agents have the disadvantage that they dissolve in water reducing the quality of the effluent and increasing the cost-requirements of the treatment. Therefore, it requires another step to eliminate these reducing agents before the treated water is disposed of.

The alternative systems are illustrated by FIGS. 1,2,3,4,5 of the drawings.

FIG. 1 illustrates a system known as the intermittent sand filter system. In the intermittent sand filter system anaerobic effluent from a septic tank is pumped into subsurface drains positioned in a sand filter. The effluent is generally pumped into one of the subsurface drains in one area of the filter bed for a period of time and then switched to pump it into the other subsurface drain or drains of the filter bed for a further period of time to allow regeneration of the bed around the first drain. In the intermittent sand filter, anaerobic slime builds up directly beneath the perforated drainpipes through which the effluent enters. The action of the intermittent sand filter is primarily mechanical and the bacterial count of effluent leaving the sand filter is not reduced substantially.

The only oxygen, which reaches the effluent in the sand filter for aerobic degradation of the fecal bacteria, is that which filters down through the top layer of sand. A major disadvantage of the intermittent sand filter is the physical size of the filter required to treat a particular amount of effluent. For example, to treat 450 gallons of effluent by such intermittent sand filter would require a sand filter accommodating two 50-foot subsurface drains.

FIG. 2 illustrates another alternative system known as the Hines-Favreau system. In the Hines-Favreau system effluent is discharged from the septic tank into a recirculating tank from where it is pumped into perforated drain positioned above the level of sand in the filter bed. The effluent trickles down through the sand filter with a portion of the effluent reentering the recirculation tank and a portion being discharged to a drain field. The portion entering the recirculation tank is again re-circulated through the sand filter. With the Hines-Favreau system a high degree of mechanical filtration occurs through the sand filter. Clumps of algae, however, tend to build up directly beneath where the effluent trickles down onto the surface of the sand filter. Over a period of time this causes channels through the filter bed to occur and inefficient and ineffective treatment results. As is true of the intermittent sand filter system, the bacterial count of effluent discharged from the sand filter of the Hines-Favreau system, although lower generally than that discharged from the intermittent sand filter system, is still too high to satisfy health authorities. After a period of time with the Hines-Favreau system, the sand filter becomes matted and clogged with filtered solids and a bacteriological mat and must be cleaned and/or the sand replaced. Otherwise the system fails.

In neither of the prior art systems described is there an effective retention/displacement cycle of the effluent within the sand filter as occurs in the system claimed. Because of the high ratio of retention time to displacement which occurs in the media bed of the system described and claimed in this application, bacterial action occurs which results in substantially lower bacteria counts in the discharged effluent.

FIG. 3 illustrates the on-site wastewater treatment system disclosed in U.S. Pat. No. 4,251,359 to Colwell, et al. In this system the effluent coming from the septic tank is collected in the dosing tank from where is pumped into the perforated pipe that distributes the effluent evenly and beneath the upper surface of the media bed. The effluent trickles down through the coarse sand filter and drained to the recirculation tank from where is pumped evenly and over the top surface of the coarse sand by time control spraying for retention and displacement there from a second time and wherein the aerobically treated effluent displaced a second time is collected for discharge. In the system decrypted the coarse sand filter after some period of time becomes clogged and the coarse sand must be replaced. Other disadvantage of the system is that the system has one stage aerobic in all step of treatment, then the Nitrification process took place, however, De-nitrification process must be poor and insufficient to remove Nitrogen from the effluent. The system has other disadvantage; the large footprint for the system in applications such as town and subdivisions is prohibited. According to EPA 625/R-00/008 the daily hydraulic load can not be higher than 5 gallons per day/square feet; for example to treat 1000 gallons per day of raw water the system need a bed area of 200 square feet.

FIG. 4 illustrates the multilayer re-circulating filter wastewater treatment apparatus disclosed in U.S. Pat. No 6,132,599 to Chaffee. In this system two filter layers containing filter media and being located atop of recirculation and dosing chambers with one basin from where the effluent is pumped and sprayed over of the first top and/or second chamber or larger according to the level in the basin and the time cycle. One of the disadvantages of this system is the particular construction that saves footprint in construction but at the same time increases cost in excavation, stronger structure and allow the possibility of leaking the effluent from the top chamber to the bottom chamber contaminating the process that took place before and become poor the quality of the discharge. In the description of this system there is no disclosure the nature of the media making impossible a further evaluation of disadvantages related with the nature of the media such as: weight, percolation rate, dimension of the filter bed and effectively of the system in BOD and TSS reduction. Finally the system is aerobic in all steps of treatment, and then the Nitrification process may occur, however De-nitrification process must be insufficient to remove Nitrogen from the effluent.

FIG. 5 illustrates the wastewater treatment apparatus and method for removing nitrogen and phosphorus disclosed in U.S. Patent Application No. 20050087480 to Park, Jong-Bok; et al. In this system is described the method to remove nitrogen and phosphorus with the wastewater treatment apparatus having an anaerobic tank, an anoxic tank, an aerobic tank and a clarifier, wherein the aerobic tank has a baffle installed at one side therefore to form a dissolved oxygen reducing zone while increasing the concentration of dissolved oxygen contained in treated effluent supplied from a part other than the dissolved oxygen reducing the zone of the aerobic tank to a clarifier in a subsequence stage. The system operates according to the lineal and continuous sequence with sludge return from Anoxic, Oxic tanks and the clarifier. The system perform as well the Nitrification and De-nitrification process by use the organic matter in the wastewater, has the disadvantage of sludge accumulation and therefore must be removed and disposed creating additional cost in operation and foot print use. Other disadvantage of this system is the retention time per each tank or stage, increasing the dimensions of this installation, increasing cost in both construction and operation.

In neither of the prior art systems there is an effective retentioh/displacement cycle of the effluent within the gravel filter as occurs in the system claimed. Because of the characteristic of the media and the cycles described the system has a facultative colony and therefore treatment as claimed in this application. The system has a specialized tank for Nitrification and De-nitrification process, as well as different stages in dosing, recirculation and discharge tanks allowing total digestion of organic water and non-sludge built up or accumulation. The system because of different stages involve in the process the growth of facultative colony in both Alternating Nitrification Enhance Reactor and the gravel media bed is able to reduce Nitrogen, BOD, and TSS levels to meet the EPA regulations, with reasonable relation of flow —foot print area of the wastewater treatment plant facilities. Using the same example related in FIG. 4 description, the 1000 gallons per day of raw water loading the system can be treated with the gravel media bed area of 37 square feet.

### BRIEF SUMMARY OF THE INVENTION

For purposes of this application, the term “media” used herein means an artificially constructed environment conducive to the growth and maintenance of microorganism colonies for the biological treatment of wastewater.

For purposes of this application, the term “facultative” used herein means in which both aerobic and anaerobic zones exist furthermore there is an anaerobic/aerobic interface subject to variations of different parameters such as dissolve oxygen level, loading conditions, mixing rate and temperature among others.

It is a primary object of this invention to provide reliability and effective modular wastewater treatment system wherein wastewater after solids separation, is facultative treated in the Alternative Nitrification Enhance Reactor to accomplish Nitrification and De-nitrification process, after that collected in the anaerobic tank to be pumped through the gravel media in a bed, collected, and uniformly distributed a second time over the same media before discharge.

It is a further object of this invention to provide a modular wastewater system wherein effluent, after solids separation, comes through the Alternating Nitrification Enhance Reactor, composed by a tank with a divider wall, having a pump (s), a venturi(s) in the second chamber and submerged plastic media container in the first chamber.

It is a further object of this invention to provide a modular wastewater system wherein effluent, after solids separation, flow to the first chamber of the Alternating Nitrification Enhance Reactor, and then flow by gravity to the second chamber, meanwhile the circulation cycle occurs between second and first chamber via venturi and submerged plastic media container.

It is a further object of this invention to provide a modular wastewater system wherein effluent, after have been treated in the Alternating Nitrification Enhance Reactor, is passed intermittently between the first area of gravel media bed and the separated second area of the same media bed with the collected effluent then being uniformly dispersed over the media in the bed through which the effluent was initially passed.

It is a further object of this invention to provide a modular wastewater treatment system wherein the effluent, after have been treated in the Alternating Nitrification Enhance Reactor, is passed through a particulate media at least twice with periodic recirculation of the effluent before discharge from the media.

It is a further object of this invention to provide a modular wastewater treatment system wherein the effluent, after have been treated in the Alternating Nitrification Enhance Reactor, is passed into a subsurface area of a bed of particulate media which retains the effluent therein for a period of time after which it is displaced from the media, collected and uniformly dispersed over the top surface of the media a second time before being displaced to the discharge tank.

It is a further object of this invention to provide a modular wastewater treatment system wherein the effluent is collected in the discharge tank and pumped to the ⅓ section of the total media bed volume for third time before being displaced and discharged.

It is a further object of this invention to provide a modular wastewater treatment system wherein the fecal bacterial count of the discharge effluent is reduced sufficiently to allow the use of the effluent as processed water for toilets or urinals, for landscape irrigation, subsurface irrigation, and/or other purposes.

These and other objects are accomplished by a method and system for a modular wastewater treatment system by effecting solid-liquid separation of the gravity settle able solids portion of the wastewater, passing the effluent with the removed solids into the Alternating Nitrification Enhance Reactor for Nitrification De-nitrification process to reduce the nitrogen level in the effluent, passing the effluent with solids and removed nitrogen into the dosing tank and after that into a bed comprising gravel media which retain the effluent therein for a period of time before displacement by additional effluent and gravity, collecting the displaced effluent and uniformly dispersing the displaced effluent over the media bed for retention and displacement a second time by the media. The effluent from the discharge tank is pumped to the ⅓ section of the total media bed volume diffusing it evenly and beneath the media for a third time. The effluent after retention and displacement a third time through the media is collected and discharged.

### BRIEF DESCRIPTION OF THE SEVERAL VIEWS OF DRAWING

FIGS. 1A and 1B are schematics of an intermittent sand filter treatment system and vertical cross-section of the intermittent sand filter.

FIGS. 2A and 2B are schematics of a typical Hines-Favreau treatment system and vertical cross-section of the sand filter.

FIG. 3 is the schematic of the on-site wastewater treatment system disclosed in the U.S. Pat. No. 4,251,359 showing the perspective of the alternating-intermittent coarse sand filter.

FIGS. 4A and 4B are schematics of the Multilayer recirculation filter wastewater treatment apparatus disclosed in the U.S. Pat. No. 6,132,599 showing a treatment system and vertical cross-section of the multilayer recirculation media filter.

FIG. 5 is the schematic of the wastewater treatment apparatus and method to remove nitrogen and phosphorus disclosed in the U.S. Patent Application No. 20050087480 showing a flow diagram of the treatment system.

FIG. 6 is the flow diagram schematic of the treatment system of this invention, having the Alternating Nitrification Enhance Reactor, Dosing Tank, Recirculation Tank, Gravel Media, Bed and Discharge System.

FIG. 7 is the plant view schematic of the treatment system of this invention, having the Alternating Nitrification Enhance Reactor, Dosing Tank, Recirculation Tank, Gravel Media Bed and Discharge System.

FIG. 7A, 7B, 7C are the vertical cross-section of the system.

FIG. 8 is a perspective view of the Modular Wastewater Treatment System wherein the media basin includes multiple drain openings and wherein a portion of the effluent displaced from the bed is re-circulated through the bed more than two times.

FIG. 9 is expanded, partial, view of one of the drainpipes in the media basin.

FIG. 10 is the schematic of the time chart versus stages of the Dosing and Recirculation System.

FIG. 11 is the schematic of the stages of the Alternating Nitrification Enhance Reactor.

FIG. 12 is the flow diagram schematic of Alternating Nitrification Enhance Reactor, Dosing, Recirculation and Drain System.

The modular wastewater treatment system as herein described may be used for treatment of municipal, residential or commercial wastes which contain no significant amounts of heavy metals and/or synthetic organics of the type discharged from chemical treatment and manufacturing facilities, electroplating industries or metal working industries. The typical effluent from municipal, residential and commercial business establishments consist primarily of human waste in admixture with biodegradable materials such as food, etc.

The wastewater to be treated generally contains gravity settable solids. While any means of effecting solid-liquid separation may be used, the most commonly used method is a grid in the collection system or a septic tank into which the wastewater is discharged and the solids allowed to be trapped or settled by gravity. The effluent living the collection system or the septic tank is anaerobic, i.e. it is not exposed to air or aeration.

The system described in this application combines certain features of the onsite wastewater treatment system disclosure in U.S. Pat. No. 4,251,359 with the new design of nitrification de-nitrification reactor in a way to create a more effective and efficient treatment system. As previously stated, the Alternating Nitrification Enhance Reactor is the first step during the treatment allowing the nitrification de-nitrification process as well as BOD sub.5 and TSS reduction. The media to be used in the first chamber of the Alternating Nitrogen Enhance Reactor is preferable plastic media.

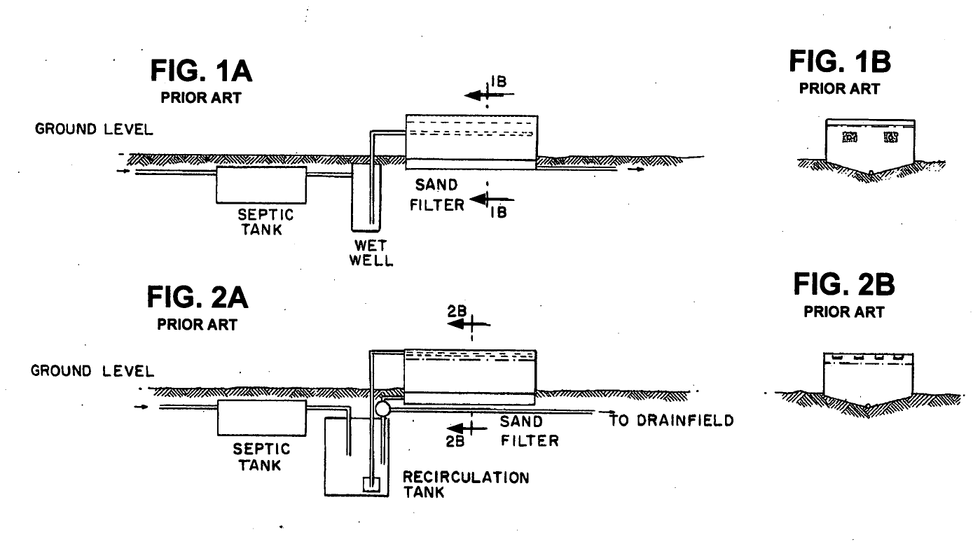

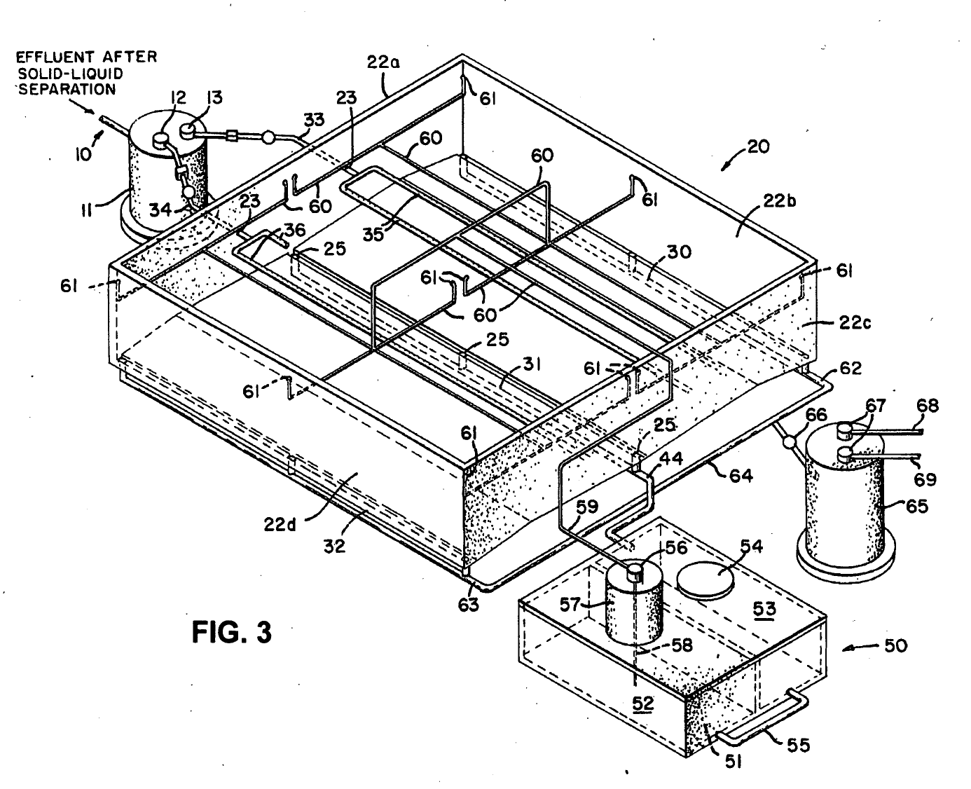

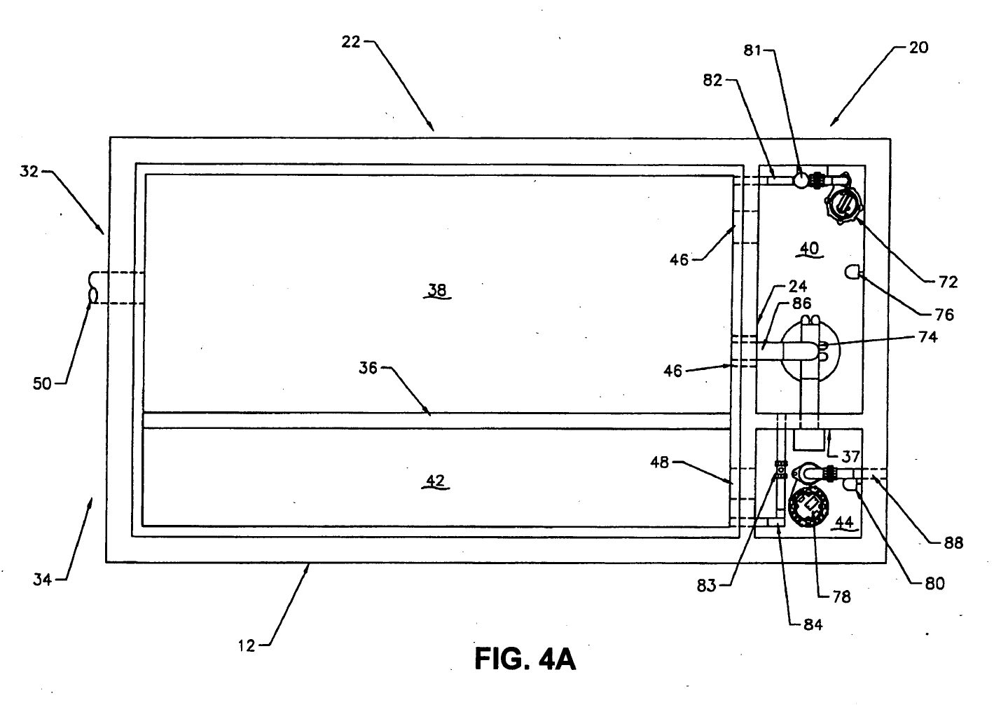

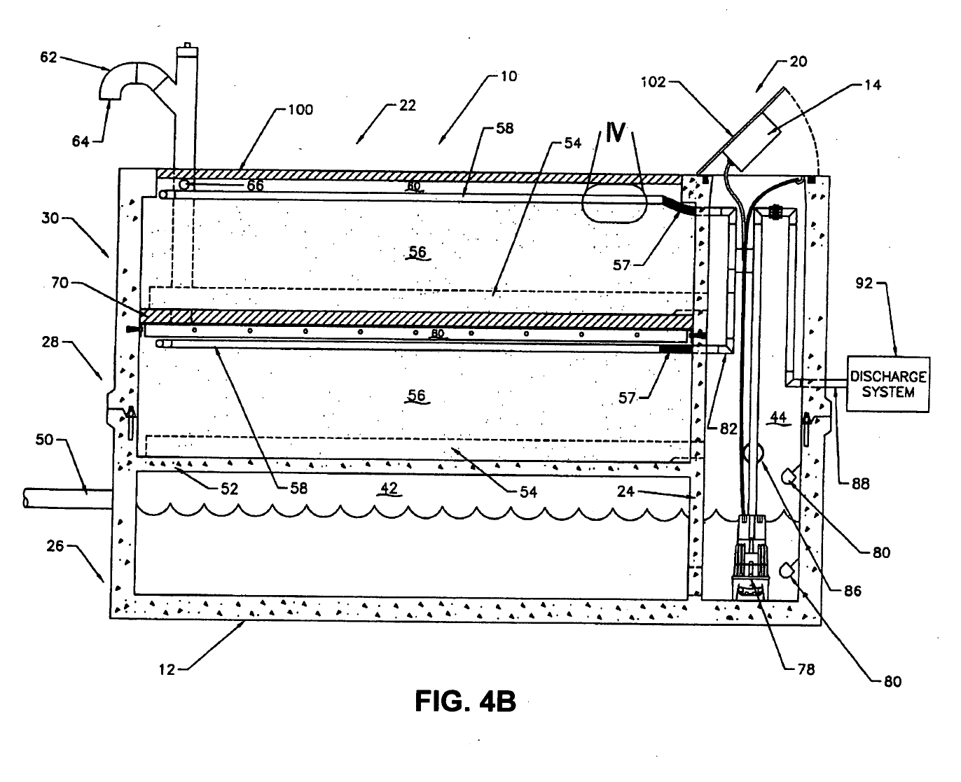

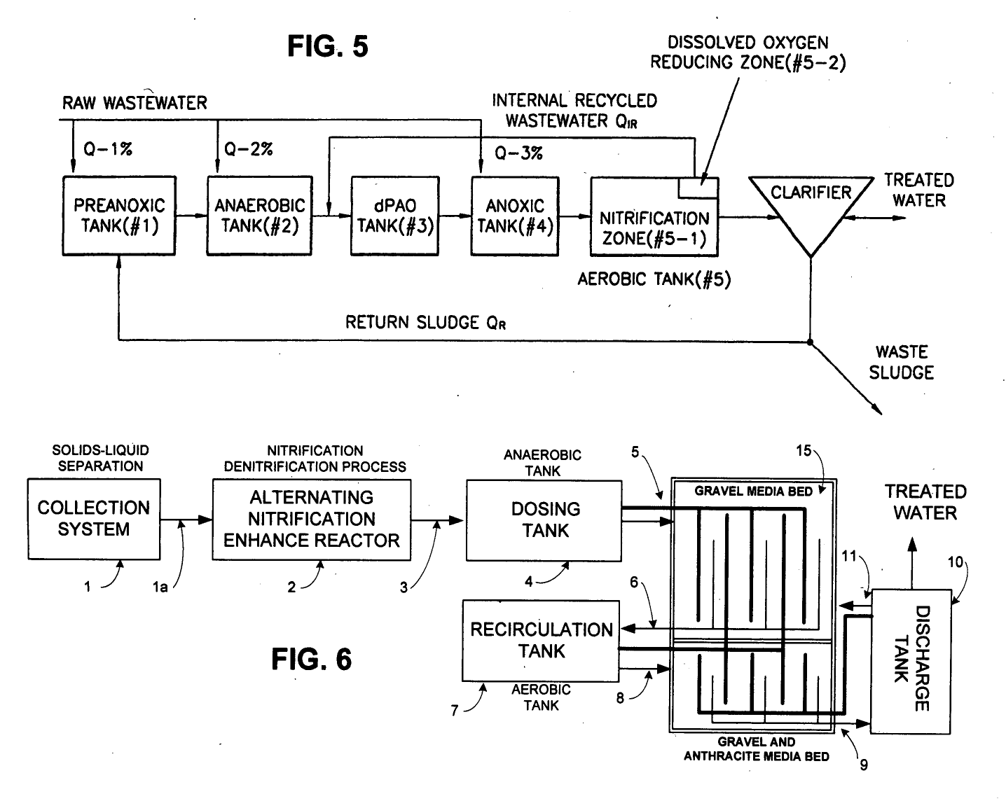

The other media described is a material conducive to growth and maintenance of the facultative colony for the biological treatment of wastewater. The media bed is gravel with a particular size specification. The ⅓ section of the total media bed volume is composed by different size of gravel and carbon anthracite. The particular characteristic and disposition of the different media described do not allow clogs or over saturation of the bed. The retention/displacement cycle which occurs in the system described in this application does not occurs to the same degree in the intermittent sand filter of FIG. 1 or the Hines-Favreau system of FIG. 2 neither in the Onsite Wastewater Treatment System disclosure in U.S. Pat. No. 4,251,359 of FIG. 3. For this three systems clogs and channels of the bed filter can occur.

The gravel material should preferable used within the following percentage of size.

UPPER 8″ TREATMENT MEDIA AND
UNDER DRAIN FILTER ROCK

| GRAVEL SEIVE SIZE | PERCENT PASSING |
|---|---|
| 1″ | 100% |
| ¾″ | 69–90% |
| ½″ | 44–38% |
| ⅜″ | 18–13% |
| ¼″ | 5–0% |
| # 10 | 0% |

LOWER 3′-4″ SECONDARY AND
TERTIARY TREATMENT ZONES

| GRAVEL SEIVE SIZE | PERCENT PASSING |
|---|---|
| ⅜″ | 80–100% |
| ¼″ | 20–14% |
| # 10 | 6–0% |
| # 50 | 0% |

CARBON ANTHRACITE

| CARBON ANTHRACITE SIZE | PERCENT PASSING |
|---|---|
| 2 × 4 mesh | 100% |

Referring to FIG. 6, the wastewater flowing to the collection system or septic tank (1) is discharged into line (1a) where it flows by gravity to the Alternating Nitrification Enhance Reactor (2) and by gravity is discharged into the line (3) where it flows to the dosing tank (4).

In the Alternating Nitrification Enhance Reactor occur nitrification de-nitrification process as well as BOD sub.5 and TSS reduction.

The dosing tank is an anaerobic storage allowing making extensive the de-nitrification process that began in the Alternating Nitrification Enhance Reactor. From the dosing tank (4) the effluent is pumped through a perforated subsurface distribution lines (5) extending to the ⅔ of the length of the basin (15).

The basin has a flat bottom surface conformed by an impermeable synthetic liner. The perforated drain lines (6) are placed over the liner are surrounding with a layer of rock. The effluent displaced through the gravel media (15) is collected in the recirculation tank (7) and sprayed evenly over the all media bed (15) (16) and displaced by gravity to the drain lines (6) (9) collecting ⅔ of the re-circulated volume to the recirculation tank (7) and ⅓ of the re-circulated effluent to the discharge tank (10).

The effluent is pumped from the discharge tank (10) through a perforated subsurface distribution lines (11) extending to ⅓ of the length of the basin (16). This section of the basin has a flat bottom surface conformed by an impermeable synthetic liner. The perforated drain lines (9) are placed over the liner and surrounding with a layer of rock. The effluent displaced across the media (16) is collected in the discharge tank (10). The final effluent is discharged from the discharge tank by gravity to the disposal system.

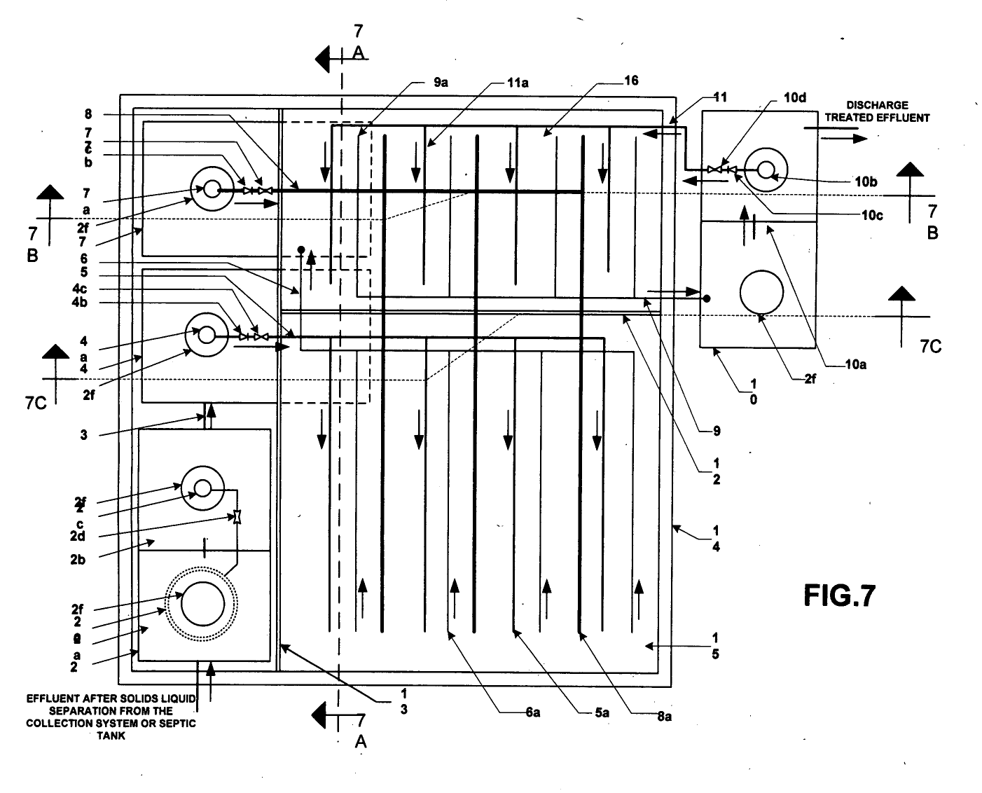

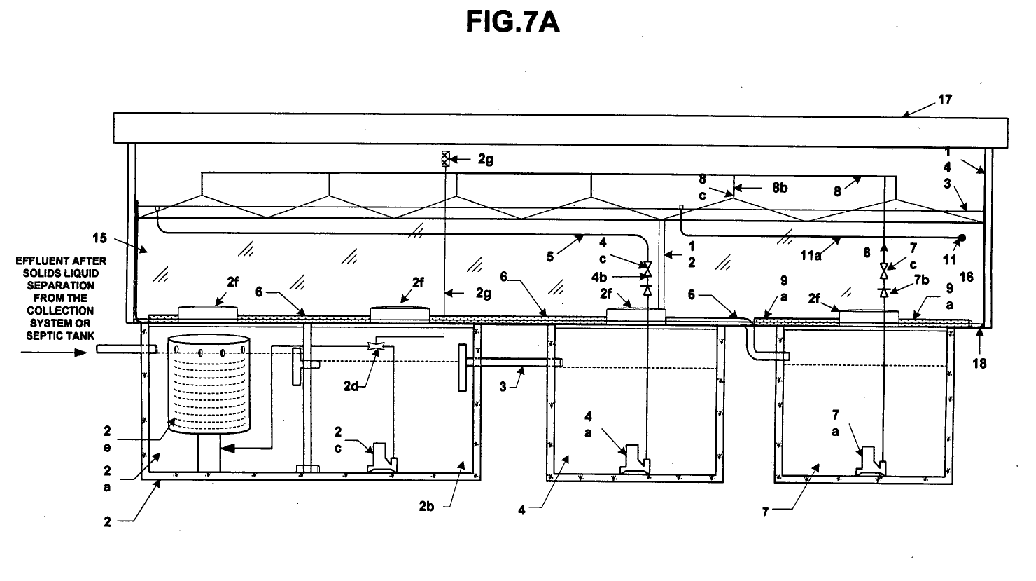

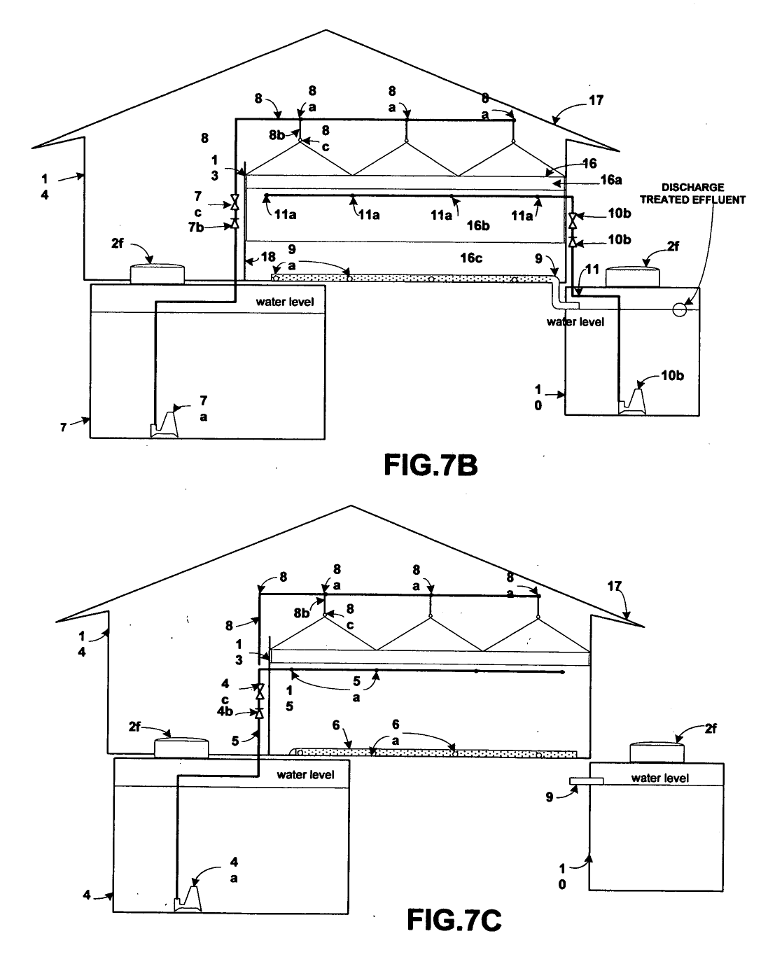

FIG. 7, 7A, 7B, 7C, the wastewater flowing to the Alternating Nitrification Enhance Reactor (2) is divided in two chambers by a divider wall, the first chamber (2a) contains a submerged plastic media (2e), the effluent flows by gravity to the second chamber (2b), where a submersible pump(s) (2c) send the effluent via venturi(s) device (2d) recirculating the effluent rich in oxygen from the bottom to the top of the submerged plastic media (2e). The tank has access for maintenance from the top with riser(s) and lid(s) (2f). The air intake pipe from the venture(s) device (2d) is extended to over the media bed surface and into the building (14) and protected at the end pipe with the fine screen and odor control device (2g).

A connection pipe (3) allows the pre-treated effluent flows by gravity to the dosing tank (4) where the effluent is storage anaerobically. The pump(s) (4a) send the pre-treated effluent in cycles through a perforated subsurface distribution lines (5) (5a) diffusing the effluent evenly in the ⅔ section of the media bed volume (15), the amount of flow is controlled by a gate valve (4c) and a check valve (4b) allows the flow in one direction.

The effluent is collected in the bottom of the basin coming through the perforated drainpipes (6a) and the main drain line (6) to the recirculation tank (7). The recirculation tank includes a submersible pump(s) (7a) which displaced the effluent via check (7b) and gate valve (7c) leading back over the total media bed volume through the re-circulation pipes (8) (8a), where is dispersed evenly by extension line and spray nozzles (8b) (8c). The effluent distributed uniformly over the media surface (15) (16) is retained by the media before displaced again across a drain line (6) (6a) and also (9) (9a), the drain lines (6) (6a) collect the ⅔ of the re-circulation effluent and send it back to the recirculation tank, mean while the drain lines (9) (9a) collect the ⅓ of the re-circulation effluent and send it to the discharge tank (10).

The discharge tank (10) receives in cycles the ⅓ of the re-circulation effluent. The discharge tank (10) is divided in two vessels by a divider wall (10a). The treated effluent flows from the first vessel to the second vessel by gravity. In the second vessel there is a submersible pump(s) (10b) which pumps via check (10c) and gate valve (10d) and circulate through the lines (11a) (11) the treated effluent uniformly beneath the surface of the ⅓ of the total media bed volume.

The treated effluent is displaced by gravity through the carbon anthracite (16b) and gravel media (16c) then collected in the bottom of the basin by the drain lines (9) (9a) and returned to the discharge tank (10) first vessel. The final effluent is displaced by gravity to the discharge line leading to a drain field or otherwise disposed of.

FIG. 7A, 7B, 7C, are vertical sections views of the general plant view FIG. 7 showing the disposition of tanks, pumps, devices, lines, media bed and overall building.

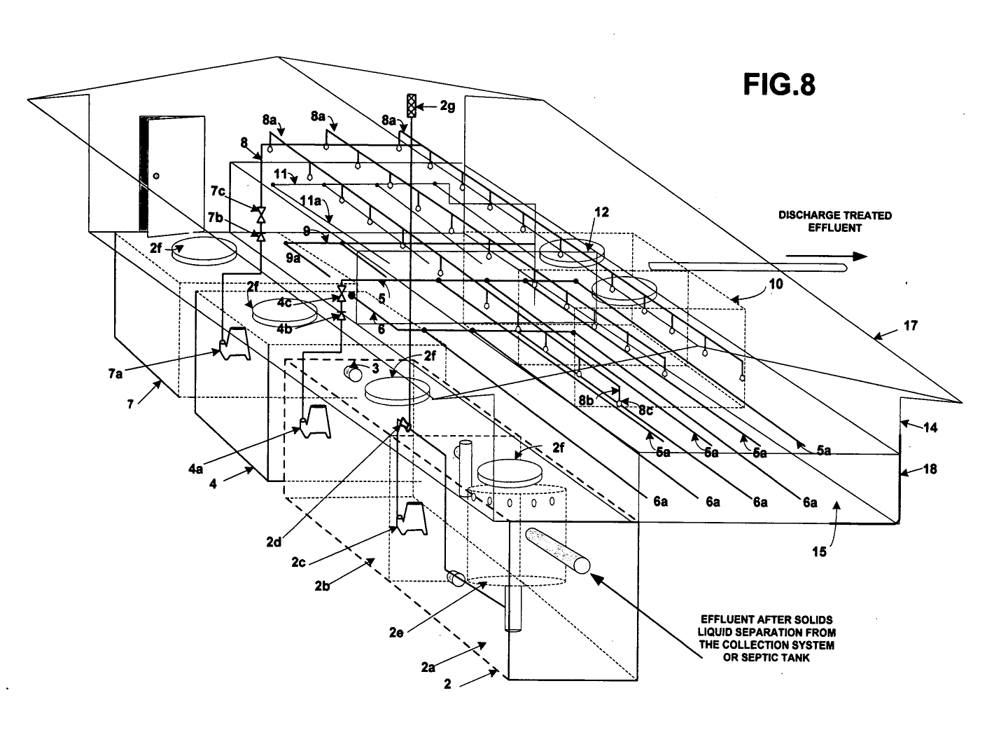

FIG. 8 is the perspective view of the system described in FIG. 7, 7A, 7B, 7C, showing the overall distribution of the system.

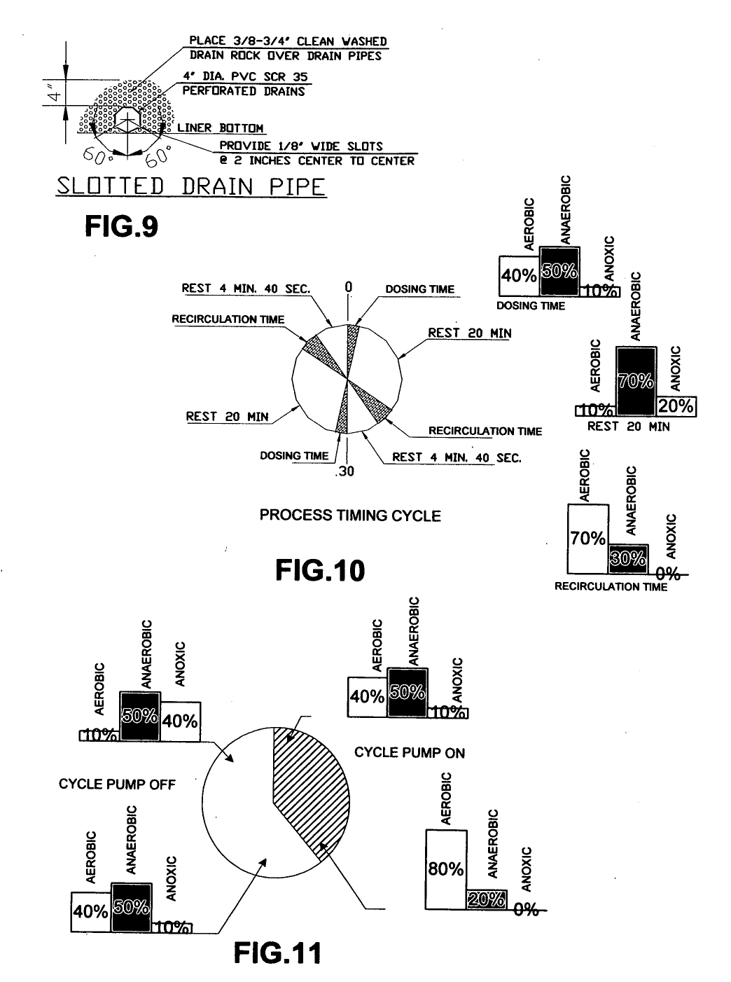

FIG. 9 illustrates a detail of the drainpipe placed in the bottom of the basin to collect the effluent. The detail shows the rock layer surrounding the slotted drainpipe over the synthetic layer.

FIG. 10 illustrates a timing cycle processes for dosing and recirculation. The bar charts show the different stages and percentage of each one during dosing time, rest time and recirculation time.

FIG. 11 illustrates a process timing cycle in the Alternating Nitrification Enhance Reactor. The bar charts show the different stages and percentage of each one during cycle pump on and cycle pump off (rest time).

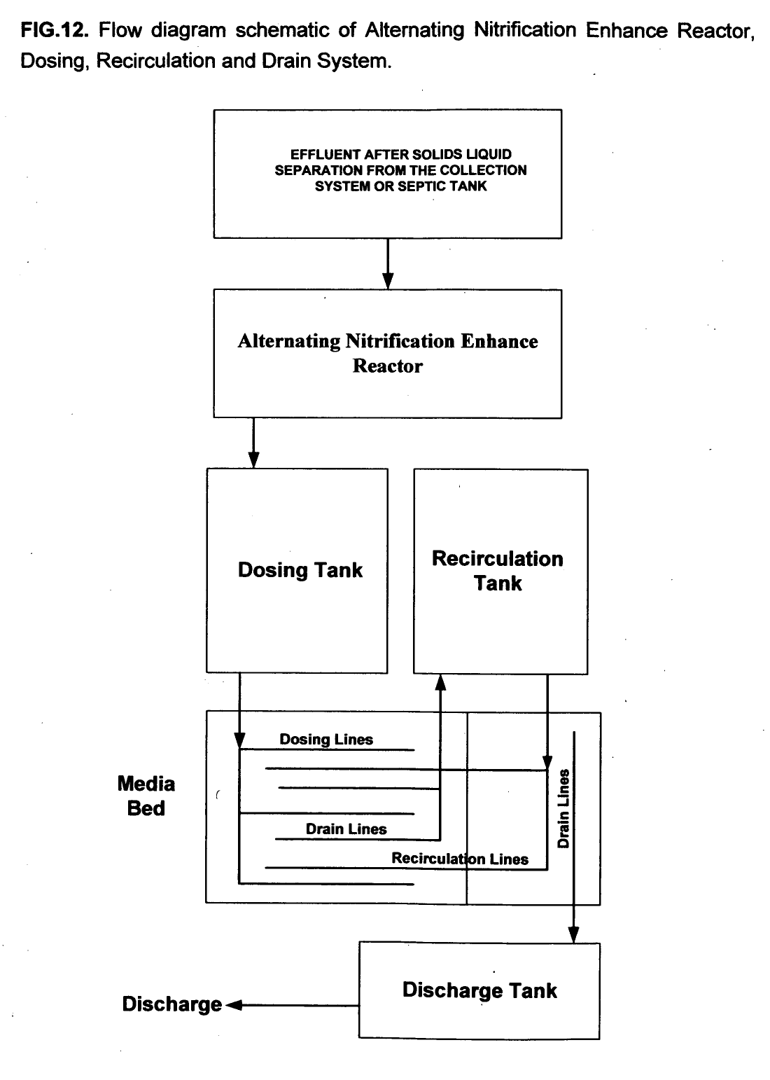

FIG. 12 illustrates a flow diagram of the Alternating Nitrification Enhance Reactor, Dosing, Recirculation and Drain System:

We claim:

1. A method of wastewater treatment comprising flowing the wastewater into the Alternating Nitrification Enhance Reactor (ANER) composed by two chambers. The first chamber contains a submerged plastic media filter, which receives the raw influent and the effluent pumped from the second chamber, enriched in oxygen provided by the venturi device, creating two (2) zones and alternating cycles. As the result the first chamber, zone one, include the following stages: aerobic, anlaerobic, anoxic and a cycling repeated, creating a facultative microorganism colony. The effluent flows from the first chamber to the second chamber by gravity, thereupon, the second chamber, zone two, include the following stages: anoxic, anaerobic, aerobic, and a cycling repeated, creating a differential facultative microorganism colony.

2. The method of claim 1 wherein the venturi device generates micro-bubbles, which have been attached to the organic material contained in the effluent, the pipe via venturi discharge into the submerged plastic media filter, comprising vertical flow from the bottom to the top of the plastic media filter. Comprising horizontal flow across the media filter.

3. The method of claim 1, where into air gaps take place in the upper media filter which is aerobic zone, middle of plastic media filter which is anaerobic zone, bottom of plastic media filter which is anoxic zone.

4. The method of claim 1, wherein the Nitrification process occurs by participation of Nitrobacter and Nitrosomonas during the aerobic cycle, in zone one and two, comprising into the upper and middle zones of submersed plastic media filter, comprising the vent pipe from the first chamber to release gases that are produced during bio-digestion on the different stages means anoxic, anaerobic and aerobic, comprising an intake air pipe supplying atmospheric air into the venturi device air intake connection.

5. The method of claim 1, wherein the wastewater BOD reduction level is described by the formula:
$$BODout = ( BODi * {BOD}_{fr} ) * {\{ [ ( RFAP * Tr / Qi ) + 1 ] exp [ \frac{{K}_{20} * As * H * {θ}^{( T - 20 )}}{{( Qi * [ ( RFAP * Tr / Qi ) + 1 ] )}^{n}} ] - ( RFAP * Tr / Qi ) \}}^{- 1}$$
Where:
BODi=Municipal or Domestic wastewater BOD₅ coming in (Mg/L)
BODout=BOD₅ level coming out from the Alternating Nitrification Enhance Reactor (ANER). (Mg/L)
BOD_{fr}=BOD₅ factor reduction in the Alternating Nitrification Enhance Reactor (ANER). (a dimensional number).
RFAP=Recirculation flow during aeration process (gpm)
Tr=Daily Recirculation time (hours/day)
K₂₀=Treatability Coefficient ((gpm/ft²)^{1/2})
As=The media specific surface area (ft²).
H=The media height (ft).
Θ=An empirical correction factor, typically set equal to 1.035.
n=An empirical flow constant, typically set to 0.5.

6. The method of claim 1 comprising the treated effluent from the Alternating Nitrification Enhance Reactor has a nitrate level less than 5 ppm, wherein the process for nitrogen compound reduction means ammonia oxidation either nitrification, furthermore partial de-nitrification process in the absence of additional carbon source take place during anaerobic-anoxic cycle.

7. The method of claim 1 comprising a temperature and odor control at the end of the air intake pipe located over the gravel filter bed level means inside the building containing the media bed, wherein the PH is maintained in the range of about 7.0 to about 8.2, comprising the PH and DO sensors in the Dosing Tank means readings to analog module into the Automatic Center Control.

8. The method of claim 1 wherein there is not sludge built up or accumulated in the chambers means in the Alternating Nitrification Enhance Reactor (ANER), comprising a facultative microorganism colony composed by aerobic, anaerobic and anoxic zones, which is a Natural Biological Cycle.

9. A method of a secondary treatment of the pretreated effluent arise from the second chamber means in the Alternating Nitrification Enhance Reactor (ANER) comprising anaerobic storage into the dosing tank of the composite pre treated effluent means to bring on a facultative microorganism colony from the Alternating Nitrification Enhance Reactor (ANER),
diffusing the composite pretreated effluent evenly into and beneath the upper surface of a bed comprising particles of media conducive to growth and maintain facultative organisms at a rate sufficient to allow the media to retain the effluent therein for a first retention time before displacement by additional effluent and gravity, collecting the displaced facultative treated effluent from the media, into the recirculation tank,
aerobic storage into the recirculation tank of the effluent collected from the bed, diffusing the collected and displaced effluent evenly over the same bed of media for retention within the media a second retention time sufficient for the facultative colony in the media to reduce the remaining pollutants of the effluent before displacement by additional effluent and gravity, the collected and displaced aerobically treated effluent containing dissolved oxygen and carrying free oxygen with it into the media to be used by aerobic bacteria contained therein, collecting and discharging the aerobically treated effluent displaced a second time from the media. The effluent treated first displaced from the media is collected and distributed evenly over the top surface of the media by the time control of the Automatic Center Control, spraying for retention and displacement there from a second time and wherein the aerobically treated effluent displaced a second time is collected for discharge at a different point than the point of collection of effluent first displaced from the media,

10. The method of claim 9 wherein the composite pre-treated effluent coming from the Alternating Nitrification Enhance Reactor (ANER) is storage in the dosing tank and after that distributed intermittently between a first surface area of the media and a second subsurface area of the same media to allow sufficient time for degradation of the organic material in the effluent held in the media by the facultative microorganism colony in the media surrounding the first and the second subsurface areas.

11. The method in claims 9 where in the rest time means time elapsed between dosing cycle and recirculation cycle, is 20 minutes. Including selectively collecting the displaced aerobically treated effluent distributed to either the first or second subsurface area of the media and distributing the displaced aerobically treated effluent evenly over the portion of the surface of the media not receiving pre-treated effluent.

12. The method of claim 9, wherein the particle size of the media bed allow either vertical and horizontal hydraulic flow, besides an adequate drainage and is such that retains the effluent within the interstices between the particles until the surface tension between the effluent held in the interstices and the particles is overcome by additional amounts of effluent and gravity, wherein the media is gravel having a grain size distribution as follows:
UPPER 8″ TREATMENT MEDIA AND
UNDER DRAIN FILTER ROCK

| GRAVEL SEIVE SIZE | PERCENT PASSING |
|---|---|
| 1″ | 100% |
| ¾″ | 69–90% |
| ½″ | 44–38% |
| ⅜″ | 18–13% |
| ¼″ | 5–0% |
| # 10 | 0% |

LOWER 3′-4″ SECONDARY AND
TERTIARY TREATMENT ZONES

| GRAVEL SEIVE SIZE | PERCENT PASSING |
|---|---|
| ⅜″ | 80–100% |
| ¼″ | 20–14% |
| # 10 | 6–0% |
| # 50 | 0% |

CARBON ANTHRACITE

| CARBON ANTHRACITE SIZE | PERCENT PASSING |
|---|---|
| 2 × 4 mesh | 100% |

13. The method of claim 9, including the control of the amount of anaerobic and aerobically treated effluent distributed to the media to allow retention of the effluent within the media enough time for the microorganisms action and biodegradation of suspended solids in the effluent to take place, wherein the gravel have adhere certain amount of clay containing a natural facultative microorganism colony, composed by bacteria colonies, protozoa colonies and other organisms such as rotifers, crustaceans, sludge worms and blood-worms, which are inherent of this natural environment, wherein other organisms maintain a balance in the populations of primary producers and break down and dissolve the organics particulate. Comprising total sludge digestion, therefore non-sludge accumulation or built up in dosing, recirculation, discharge tanks and media gravel bed occurs.

14. The method of claim 9, wherein-the gravel media bed area is described by the formula, using EPA 625/R-00/008 as criteria of BOD5 loading a gravel filter.
A_{BF}=4.587*10⁻⁴*BODout*Q
Where:
ABF=Overall area of gravel bed filter (sq.ft)
BODout=BOD5 concentration in Mg/L coming out from the Alternating Nitrification Enhance Reactor (ANER).
Q=Flow in gallons per day coming out from the Alternating Nitrification Enhance Reactor (ANER) (GPD)
wherein the daily hydraulic load the gravel bed filter is described by the following formula:
Rhl=Q/ABF
Where:
Rhi=Daily hydraulic load loading the gravel bed filter. (GPD/sq.ft)
Q=Flow in gallons per day coming out from the Alternating Nitrification Enhance Reactor (ANER) (GPD)
ABF=Overall area of gravel bed filter (sq.ft)

15. A modular wastewater treatment system comprising a wall that divides the media bed in two sections, the first section is ⅔ of the total media. bed volume, which receives the effluent from the dosing tank evenly and beneath, the gravel media, as well as the ⅔ of the effluent from the recirculation tank is sprayed over the gravel media surface and after that it is drained into the recirculation tank during the recirculation cycle, comprising a drainage system which drains the treated effluent into the discharge tank divided in two sections, wherein the second section has a submergible pump that send the treated effluent to the Nitrogen Removal Distribution System composed by the ⅓ of the media bed volume containing carbon anthracite or activated carbon and the distribution lines which diffuse in cycles and evenly the treated effluent beneath the media bed for nitrogen removal, wherein the same drainage system collects the treated effluent with the removed nitrogen and carryout the effluent to the discharge tank repetitively until the effluent is discharged by gravity and overflow from the discharge tank to the drain field via discharge pipe.

16. The system of claims 9 wherein the first and second distribution system are positioned within the media basin so that substantially all of the pretreated effluent from the ANER passing by the first and the second distribution systems, after the first retention time within the media, is discharged through the first outlet means from the media basin via drainage system to the recirculation tank, wherein the media basin provided with means for separating the displaced aerobically treated effluent so that the effluent flowing there through the first time is discharged through the first outlet means and ⅓ section of the effluent flowing there through for the second time is discharged through the second outlet means from ⅓ section of the total media bed volume via drainage system to the discharge tank. Including automatic control center means operatively connected to the first and second subsurface distribution systems for switching pre-treated effluent flow between the first subsurface distribution system and the second subsurface distribution system.

17. The system of claim 9 wherein the media basin is separated into two different portions with the first distribution system for diffusing pre-treated effluent within one of the separated portions and the second distribution system to diffuse pre-treated effluent into the other separated portion and wherein the recirculation means for distributing the re-circulated effluent over the surface of the media in the basin not receiving the pretreated effluent through its subsurface distribution system, wherein the treated effluent from the discharge tank is displaced anaerobically through for the third time and it is discharged from the ⅓ section of the total media bed volume via drain system to the discharge tank, wherein the treated effluent with removed nitrogen is discharged by gravity and overflow to the drain field via discharge pipe means outlet in the discharge tank.

18. The system of claim I wherein the Alternating Nitrification Enhance Reactor (ANER) (2) means includes (2a) first chamber receiving untreated effluent from collection tank or septic system, (1) the effluent flow through the first outlet to the second chamber (2b), a submersible pump (2c) to pump the untreated effluent via venturi device (2d), generating micro bubbles and becoming the effluent into aerobically treated, which is injected to the submersed plastic media (2e) in the first chamber (2a). The ANER operate by alternating cycles, wherein the pretreated effluent from the Alternating Nitrification Enhance Reactor via a connection pipe (3) is storied into the dosing tank (4) for further displacement into and beneath the ⅔ section of the gravel media bed (15) to be aerobically treated within the media basin and be displaced by gravity through the drain system (6) to the recirculation tank (7),
wherein the recirculation tank (7) receives the displaced aerobically treated effluent flowing through the first outlet means of the media basin, a submersible pump (7a) for pumping the aerobically treated effluent from the recirculation tank (7), and one or more nozzles (8c) connected to the line (8) (8a) (8b) to inject the aerobically treated effluent to the air above the media (15) (16) for even distribution thereof into the surface of the media for retention and displacement thereby a second time, the re-circulated aerobically treated effluent within the media through the second outlet means of the basin to drain line (9) (9a) for discharge,
comprising a discharge tank (10) where the treated effluent is pumped (10b) from the discharge tank (10) to the ⅓ section of the total media bed volume (16) to be treated anaerobically to remove the nitrogen and displaced by gravity through the drain lines (9) (9a) to the discharge tank repeatedly until the final effluent is discharged by gravity.

19. The system of claim 1 wherein the separation means is a collection system or septic tank having an inlet that receives the untreated wastewater containing solids therein and an outlet connected to the Alternating Nitrification Enhance Reactor,
wherein the activated carbon contained in the ⅓ section of the total media bed volume removes essentially all of the soluble biodegradable organics associated with the suspended solids, furthermore in the quaternary treatment before discharge within the media bed the activated carbon removes inorganic compounds such as nitrogen and sulfides,
comprising the treated effluent is diffused under anaerobic conditions evenly over the quaternary treatment separated portion, wherein take place de-nitrification process by the action of facultative microorganism biomass.

20. The system of claim 1 wherein the effluent containing minimal suspended solids and low bacterial count, comprising:
A collection system or septic tank having an inlet that receives untreated wastewater containing solids therein and an outlet connected to the Alternating Nitrogen Enhance Reactor (ANER), the collection system or septic tank effects the solid-liquid separation and the delivery of an anaerobic untreated effluent to the inlet of the Alternation Nitrification Enhance Reactor means a tank with an internal division wall creating two chambers means first chamber and second chamber,
the Alternating Nitrification Enhance Reactor having an inlet receiving the anaerobic untreated effluent from the collection system or septic tank, the Alternating Nitrification Enhance Reactor effects the nitrification process, BOD and suspended solids biodegradation and the delivery of the pre-treated effluent to the dosing tank for the subsequent subsurface distribution,
a basin containing particles of a media conduces to the growth and maintenance of the facultative microorganism colony for the biological treatment of pretreated wastewater,
subsurface effluent distribution means to position the particles of the media in the basin which receives the pre-treated effluent from the Dosing tank through the Alternating Nitrification Enhance Reactor and distributes it through the media for retention thereby for facultative microorganism action and biodegradation of the suspended solids until be displaced by gravity, the subsurface distribution means including a first subsurface distribution system for diffusion of the pretreated effluent within a first discrete area of the media and a second distribution system for diffusion of the pretreated effluent within a separated discrete second area of the media,
first outlet means in the bottom wall of the basin beneath the subsurface distribution means to collect the aerobically treated effluent displaced from the media,
a Recirculation Tank receiving the displaced aerobically treated effluent discharged from the first outlet means in the basin,
for time control pumping of the displaced aerobically treated effluent from the Recirculation Tank and injecting it into the air above the media in the basin for even distribution across the surface of the media for retention by the media a second time, the re-circulated aerobically treated effluent displaces retained effluent held within the media, comprising a oxygen decay into the gravel media, becoming in facultative zone,
a second outlet means in the basin that receives a portion of the facultative treated effluent retained and displaced a second time from the media,
connecting with the second outlet from the basin receiving the facultative treated effluent in the discharge tank, connecting with the third outlet from the discharge tank means discharge the final effluent for direct disposal.

21. The system of claim 1, including Automatic Center Control with the time control means operatively connected to the Alternating Nitrification Enhance Reactor, first and second subsurface distribution systems by switching the effluent flow according to the sequence to obtain stages anoxic, anaerobic and aerobic in the Alternating Nitrification Enhance Reactor and the effluent flow between the first subsurface distribution system and the second subsurface distribution system,
comprising Automatic Center Control including an Alternating Nitrification Enhance Reactor tank level control with low level on-off operation and high level alarm, cycle control timer, a dosing tank level control with low level on-off operation, override level and high level alarm, dosing pump cycle control with low level on-off operation, override level and high level alarm, dosing pump cycle control timer, a recirculation tank level control with low level on-off operation, override level and high level alarm, recirculation pump cycle control timer,
comprising a building where is enclosed the Alternating Nitrification Enhance Reactor, Dosing and Recirculation tanks, gravel media bed and discharge means outlet or discharge tank for direct disposal of the final treated effluent.
